(19) United States
(12) Patent Application Publication
(10) Pub. No.: US 2026/0042116 A1
(43) Pub. Date: Feb. 12, 2026

(54) METHOD OF COATING AND COATING MACHINE

(71) Applicant: Sollich KG, Bad Salzuflen (DE)

(72) Inventors: Maximilian König, Bad Salzuflen (DE); Rüdiger Bläsing, Bielefeld (DE); Maximilian Schmidt, Bad Salzuflen (DE)

(73) Assignee: Sollich KG, Bad Salzuflen (DE)

(21) Appl. No.: 19/209,583

(22) Filed: May 15, 2025

(30) Foreign Application Priority Data
Aug. 12, 2024 (EP) 24194110.3

(51) Int. Cl. B05C 11/06; B05C 13/00; B05D 3/00

(52) U.S. Cl. CPC B05C 11/06; B05C 13/00; B05D 3/007

(57) ABSTRACT

Various embodiments include methods and machines for coating objects with a flowable coating mass, where the coating mass is applied to the objects. Excess applied coating mass is blown off from the objects resting on an upper run of a grid belt and conveyed by moving the upper run in a conveying direction. From undersides of the objects resting on the upper run and conveyed by moving the upper run in the conveying direction, the excess applied coating mass is blown off using at least one first gas jet which is blown out at a first blow-out position, that is arranged below the undersides of the objects and, with respect to the conveying direction, laterally beside the undersides of the objects.

### CROSS REFERENCE TO RELATED APPLICATIONS

This application claims priority to co-pending European Patent Application No. EP 24 194 110.3 entitled “Verfahren zum Überziehen und Überziehmaschine” and filed Aug. 12, 2024, the entire disclosure of which is hereby incorporated herein by reference in its entirety.

### FIELD OF THE INVENTION

The invention relates to a method of coating objects with a flowable coating mass. More particularly, the invention relates to a method of coating objects with a flowable coating mass comprising the steps of applying the coating mass to the objects and blowing off excess applied coating mass from the objects resting on an upper run of a grid belt and conveyed by moving the upper run in a conveying direction.

Further, the invention relates to a coating machine for coating objects with a flowable coating mass.

### BACKGROUND OF THE INVENTION

German patent DE 42 43 814 C1 and U.S. Pat. No. 5,437,723 belonging to the same patent family disclose a coating machine and a corresponding method of coating articles with chocolate. In the coating machine, a grid belt is arranged as an endless belt, which is driven in circulation. An upper run of the grid belt extends from an input-side deflection, which is implemented with a bar or shaft, up to an output-side deflection, which is also implemented with a bar or shaft. During operation of the coating machine, the upper run of the grid belt is approximately in the plane defined by the deflections. Various units are arranged below the upper run, including a bottom coating station, a vibrating device and a bottom scraper shaft. These units are located directly below the upper run and get into contact with the liquid coating mass during operation of the coating machine. As a result, coating mass is deposited on these units so that these units have to be cleaned, especially when the coating mass is changed. The bottom coating station has a dipping roller, a bottom levee tray and various trays, which also get into contact with the chocolate. A coating station is provided in the upper area of the coating machine, the main component of which is a veil box, via which the liquid chocolate falls freely onto the articles on the upper run of the grid belt. A blower is installed downstream of the coating station in the direction of passage of the articles on the grid belt, which blows air via a nozzle-like lip onto the articles that have just been coated with liquid chocolate, so that excess chocolate is blown off, passes through the upper run of the grid belt and enters a trough located below.

Different coating masses have different viscosities. While the coating machine known from German patent DE 42 43 814 C1 and U.S. Pat. No. 5,437,723 is well suited to coating articles with chocolate in such a way that a layer of chocolate of the desired uniform thickness is formed on all surfaces of the articles, it is difficult to form thinner closed coatings of higher viscosity coating masses with this coating machine. Such all-round closed coatings are not only an optical advantage, but also protect the articles enclosed in them from atmospheric oxygen, humidity and other external influences.

There still is a need of a method of coating and a coating machine for coating objects with a flowable coating mass which are suitable for forming thin coatings on the objects which are closed on all sides, even from higher viscosity coating masses.

### SUMMARY OF THE INVENTION

The present invention relates to a method of coating objects with a flowable coating mass. The method comprises the steps of applying a flowable coating mass to objects, each object having an upper side, side surfaces and an underside, of arranging the objects on an upper run of a grid belt, of conveying the objects resting on the upper run by moving the upper run in a conveying direction, and of blowing off excess applied coating mass from the objects resting on the upper run and conveyed in the conveying direction. The step of blowing off excess applied coating mass from the objects includes blowing out at least one first gas jet at a first blow-out position that is located below the undersides of the objects resting on the upper run and, with respect to the conveying direction, laterally beside the undersides of the objects resting on the upper run, and blowing off excess applied coating mass from the undersides of the objects resting on the upper run and conveyed in the conveying direction using the at least one first gas jet.

The present invention further relates to a coating machine for coating objects with a flowable coating mass. The coating machine comprises a mass application device configured for applying a flowable coating mass to objects, a conveying device having a circulating grid belt with an upper run and configured for conveying the objects resting on the upper run of the grid belt by moving the upper run in a conveying direction, and a blow-off device arranged above the upper run of the grid belt and configured for blowing off excess applied coating mass from the objects resting on the upper run and conveyed in the conveying direction. The upper run, viewed in a transverse direction to the conveying direction, comprises at least one object receiving area having an upper side with object support points and, on at least one side of the at least one object receiving area, a low area that runs through in the conveying direction and that is lowered relative to the at least one object receiving area. A lower end of the blow-off device can be lowered or is lowered above the low area to a height level below the lowest object support points of an upper side of the at least one object receiving area.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic view of essential components of a coating machine according to the present disclosure and thus also of essential steps of a method according to the present disclosure.

FIG. 2 is a perspective view of a section of an upper run of a grid belt of the coating machine as shown in FIG. 1 with cuboid objects to be coated arranged thereon and various parts of a blow-off device for blowing off excess applied coating mass from the objects.

FIG. 3 shows the arrangement according to FIG. 2 in a view from the front against a conveying direction in which the objects resting on the upper run are conveyed, whereby a hold-down device for the objects is also shown.

FIG. 4 is a side view of the arrangement shown in FIG. 2.

FIG. 5 and FIG. 6 are views of an arrangement corresponding to FIGS. 2 and 3 with a configuration of the grid belt adapted to cylindrical products to be coated, but without the additional hold-down device shown in FIG. 3.

FIG. 7 and FIG. 8 are views corresponding to FIGS. 2 and 3 of an arrangement with a design of the grid belt adapted to spherical products to be coated, again without showing the additional hold-down device according to FIG. 3; and

FIG. 9, FIG. 10 and FIG. 11 are views, corresponding to FIGS. 2 to 4, of an arrangement with a design of the grid belt adapted to puck-shaped products to be coated, a mass application device for applying the coating mass to the objects being shown as well.

### DETAILED DESCRIPTION

In a method according to the present disclosure of coating objects with a flowable coating mass comprising the steps of applying the coating mass to the objects and blowing off excess applied coating mass from the objects resting on an upper run of a grid belt and conveyed by moving the upper run in a conveying direction, the excess applied coating mass is blown off from the undersides of the objects resting on the upper run and conveyed by moving the upper run in a conveying direction using at least one first gas jet, which is blown out at a first blow-out position, that is located below the undersides of the objects and, in relation to the conveying direction, laterally beside the undersides of the objects.

The method of coating the objects with the flowable coating mass may therefore be implemented according to the present disclosure primarily with regard to blowing off the excess applied coating mass. How the coating mass is applied to the objects is sometimes less decisive for the method according to the present disclosure. As with the coating machine described at the beginning, the coating mass may flow down from a veil box from above onto the objects on the upper run, and further coating mass may be applied to the objects from below in a bottom coating station. The coating mass may also be applied to the objects in a mixing drum, or the objects may be temporarily immersed in the coating mass.

An essential feature of the implementation of the blowing-off of the excess applied coating mass according to the present disclosure is the blowing-off of the excess applied coating mass from the undersides of the objects. This blowing-off takes place with the first gas jet, namely from a first blow-out position, which is arranged below the undersides of the objects, but laterally beside the undersides of the objects in relation to the conveying direction. The blow-out position is therefore not located in any area directly below the undersides of the objects in which area the blow-out position would be affected by the coating mass flowing or dripping down.

The at least one first gas jet may be oriented orthogonally to the conveying direction, or at a slightly acute or slightly obtuse angle to the conveying direction. However, the angle to the conveying direction is regularly not outside a range of 60° to 120° and usually not outside a range of 75° and 105°. In relation to the horizontal, the at least one first gas jet may be oriented horizontally or at a small angle upwards. As a rule, this small angle is 45° at maximum. Usually, this small angle is in a range from 0° to 30° and often in a range from 0° to 15°.

It shall be understood that when the excess applied coating mass is blown off from the objects, the coating mass is blown over the surfaces of the objects, which is favorable for the formation of a closed coating. In this way, the at least one first gas jet also ensures that the undersides of the objects are completely coated with the coating mass. This is the case even though the undersides of the objects rest on the upper run of the grid belt and are therefore linearly covered by the grid belt links. The coating mass tends to be blown even into the covered areas of the underside of the objects with the first gas jet.

When the excess applied coating mass is blown off from the undersides of the objects, the objects can be held down on the upper run using at least one further gas jet. This prevents the objects from being unintentionally lifted off the upper run by the action of the at least one first gas jet. Specifically, the objects-viewed in the conveying direction-can be subjected to at least one further gas jet in the area of each first gas jet, which at least one further gas jet is directed downwards onto the upper sides of the objects in order to hold the objects down on the upper run. Before being blown off from the undersides, the excess applied coating mass may be blown off from both side surfaces of the objects resting on the grid belt and conveyed by moving the upper run in the conveying direction using at least two second gas jets. These second gas jets are blown out at second blow-out positions, that are laterally opposite the two side surfaces of the objects in relation to the conveying direction. The second gas jets may be oriented to the conveying direction at a slightly acute or slightly obtuse angle in a range of 60° to 150° or in a range of 75° to 105°; and the second gas jets can be oriented horizontally or inclined downwards at an angle to the horizontal. This angle may be up to 75°. Often this angle is not greater than 60°, usually it is not greater than 45°, and it can be in the range of 0 to 30°.

Even before blowing off from the two side surfaces, the excess applied coating mass can be blown off from the upper sides of the objects resting on the upper run and conveyed by moving the upper run in the conveying direction using at least one third gas jet. This at least one third gas jet is blown out at a third blow-out position, which is arranged above the upper sides of the objects and without lateral offset to them. Like any second gas jet, this third gas jet may be blown out through a lip-shaped nozzle or a row of hole-shaped nozzles extending transversely to the conveying direction, with the row or nozzle for the third gas jet being arranged above the upper sides of the objects. The at least one third gas jet is generally directed vertically downwards, but may be inclined at a small angle to the vertical in the conveying direction or against the conveying direction. This small angle is usually no more than 45°. As a rule, this small angle is not greater than 30°. Often it is in the range of 0 to 15°.

In one embodiment, the excess applied coating mass is blown off from the undersides of the objects resting on the upper run and conveyed by moving the upper run in the conveying direction with at least two first gas jets, which are blown out at first blow-out positions arranged below the undersides of the objects and, with respect to the conveying direction, on both sides beside the undersides of the objects. The undersides are therefore blown off from both sides with at least one first gas jet each.

In another embodiment, the excess applied coating mass is blown off from the undersides of the objects with at least one group of first gas jets which are blown out at first blow-out positions which are arranged below the undersides of the objects and, with respect to the conveying direction, laterally beside the undersides of the objects one behind the other. Each underside of each object is therefore blown off from one side not just with one gas jet, but with a group of first gas jets, which are blown out at blow-out positions located one behind the other in relation to the conveying direction. The relative arrangements of the blow-out positions to the undersides of the objects and/or the orientations of the individual first gas jets to the conveying direction and/or to the horizontal can be the same or different. The excess applied coating mass may be blown off from the undersides of the objects with two groups of first gas jets, which are blown out at first blow-out positions which are arranged below the undersides of the objects and, with respect to the conveying direction, on both sides beside the undersides of the objects one behind the other. The plurality of first gas jets blown onto the underside of each object can be decisive for achieving the desired result of a thin, but closed coating in the case of particularly viscous coating masses. Specifically, 5 to 50 first blow-out positions can be arranged in succession on both sides beside the undersides of the objects. On the other hand, it is generally not necessary to also blow out several second and/or third gas jets in succession in the conveying direction onto the side surfaces or the upper surfaces of the objects.

It is understood that the gas jets blown out in the method according to the present disclosure will generally be jets of air. In principle, however, these gas jets may also have a composition that differs from the air in the surroundings. In principle, the air may be purified and enriched or depleted with respect to one or more gaseous components before the gas jets are formed.

Furthermore, it shall be understood that the ordinal numbers first, second and third figures with regard to the gas jets, first, second and third with regard to the blow-out positions etc. only serve to differentiate between the various gas jets, blow-out positions etc., but do not directly provide any further information.

It is possible that parts of a blow-off device for blowing out the first gas jets are arranged below the upper run of the grid belt, even if these parts may there be more strongly exposed to contamination by coating mass dripping off the upper run.

Further, it is possible that a lower end of a blow-off device for blowing out the first gas jets dips from above between individual, horizontally spaced tracks of the upper run of the grid belt to below the upper run. The first blow-out positions are then arranged or at least supported below the upper run, but laterally offset to the individual horizontally spaced tracks of the upper run of the grid belt.

In addition to a mass application device which is configured for applying the coating mass to the objects, and a conveying device comprising a circulating grid belt which is configured for conveying the objects resting on an upper run of the grid belt by moving the upper run in a conveying direction, a coating machine according to the present disclosure for coating objects with a flowable coating mass comprises a blow-off device arranged above the upper run and configured for blowing off excess applied coating mass from the objects resting on the upper run and conveyed by moving the upper run in the conveying direction. The upper run of the grid belt of the coating machine according to the present disclosure—viewed in the transverse direction to the conveying direction—has at least one object receiving area and, on at least one side of each object receiving area, a low area running through in the conveying direction and lowered relative to the respective object receiving area. Above this low area of the upper run, a lower end of the blow-off device can be lowered or is lowered to a height level below the lowest support points of an upper side of the object receiving area.

This enables the blow-off device to blow off the excess applied coating mass from the undersides of the objects resting on the upper run and conveyed by moving the upper run in the conveying direction, namely from below the undersides of the objects, although the blow-off device is arranged above the upper run. There, the blow-off device is less strongly exposed to the risk of contamination by the excess applied coating mass and is generally more accessible.

The mass application device may be configured for applying the coating mass to the objects resting on the upper run and conveyed by moving the upper run in the conveying direction. However, the mass application device may also be connected upstream of the grid belt of the conveying device.

The lower end of the blow-off device may have a blow-out opening which can be lowered or is lowered at least partially above the low area to a height level below the lowest support points of the at least one object receiving area. The blow-out opening may be oriented horizontally or at a small angle to the horizontal of no more than 30° and typically of no more than 15° towards the at least one object receiving area.

In an embodiment of the coating machine,—viewed in the conveying direction—a hold-down device is arranged above the upper run in the area of the lower end of the blow-off device, which hold-down device applies at least one further gas jet to the objects. The at least one further gas jet is directed downwards onto the upper sides of the objects in order to hold the objects down on the upper run contactlessly.

Specifically, an upper side of the low area may be lowered by at least 3 mm, by at least 6 mm or by at least 10 mm as compared to the lowest support points of the at least one object receiving area. Depending on the width of the objects, these lowerings are generally sufficient for blowing off from the undersides of the objects. At the same time, these lowerings only hinder the circulation of an endless grid belt to a tolerable extent due to the formation of the low area. The manageability of the endless grid belt when circulating sets a limit to the lowering of the low area in relation to the lowest support points of the upper side of the at least one object receiving area, which is a few centimeters depending on the dimensions of the grid belt. To carry out the method according to the present disclosure, however, it is generally not necessary to lower the low area by more than 3 cm. In many cases, a maximum of 2 cm is also sufficient.

In the at least one object receiving area of the upper run, alternating object supports and object driving dogs can be formed in the conveying direction. The object driving dogs are raised in relation to the object supports and thus ensure that the objects are carried along by the circulating grid belt in such a way that the objects have the same speed as the upper run in the conveying direction. Specifically, the object driving dogs can be raised by at least 2 mm, by at least 4 mm or by at least 6 mm compared to the object supports. Typically, the object driving dogs are raised by no more than 3 cm and in many cases by no more than 2 cm compared to the object supports.

Alternatively or additionally, the at least one object receiving area may have a channel shape when viewed in the transverse direction to the conveying direction, at least in the area of object supports. In this case, lateral edges can also be raised by at least 2 mm, by at least 4 mm or by at least 6 mm in relation to the lowest support points of the at least one object receiving area. The typical upper limit of 3 cm and often 2 cm for the elevation also applies here.

In an embodiment of the coating machine, the object driving dogs and the channel shape of the at least one object receiving area form successive object receiving nests in the conveying direction, the edges of which are raised in all horizontal directions relative to the lowest support points of the at least one object receiving area.

The coating machine may have a removal device arranged below the upper run of the grid belt, which is configured for removing excess applied coating mass from an underside of the upper run and/or from undersides of the objects resting on the upper run. The removal device may act on the grid belt not only in the at least one object receiving area, but also in each adjacent low area, in order to prevent a build-up of blown-off excess coating mass in the low areas as well.

The removal device may comprise a wiper roll which is driven for rotation about an axis of rotation extending in a transverse direction to the conveying direction, for example in such a way that an upper side of the wiper roll that faces the underside of the upper run moves counter to the conveying direction. The shape of the wiper roll of the removal device required for the engagement of the removal device with the grid belt both in the at least one object receiving area and in each adjacent low area differs greatly from the wiper rolls of known coating machines.

The coating machine may furthermore comprise a vibrating device which engages with the upper run of the grid belt and is configured for shaking off excess applied coating mass from the objects resting on the upper run and from the upper run itself. Such vibrating devices are known, for example, from the prior art of chocolate coating machines.

The application device of the coating machine may comprise a veil box arranged above the upper run and a bottom levee arranged below the upper run, wherein the bottom levee has a levee top side corresponding to the underside of the upper run of the grid belt at least in the object receiving area, and a downwardly directed mass outlet opening in the levee top side. In the coating machine, the shape of the levee top side of the bottom levee also differs significantly from the bottom levees of known coating machines.

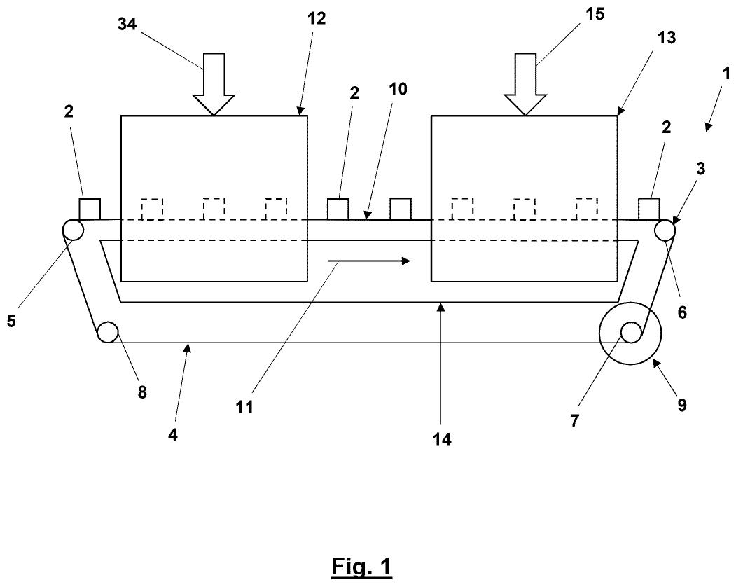

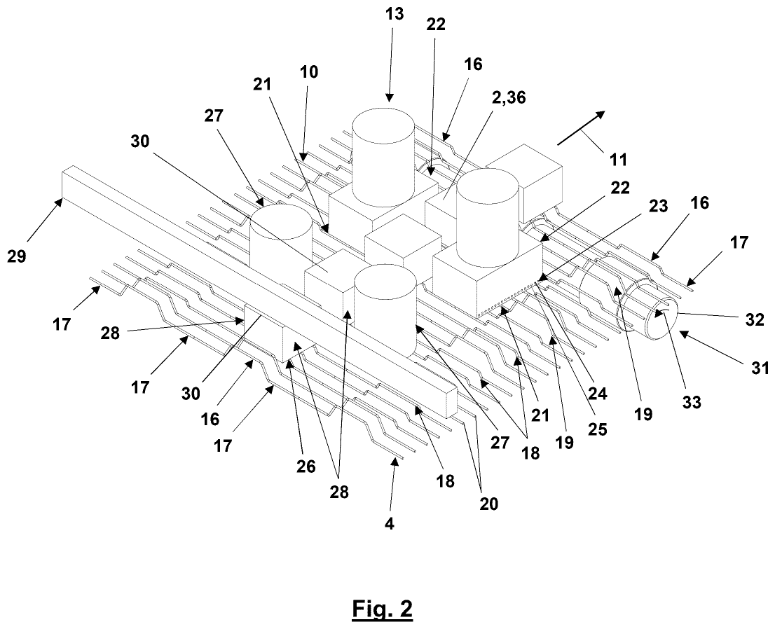

Now referring in greater detail to the drawings, the coating machine 1 shown schematically in FIG. 1 in the form of essential components is used for coating objects 2 with a flowable coating mass 34. A conveyor device 3 of the coating machine 1 has a circulating grid belt 4, which is guided around deflection rollers 5 to 8. The deflection roller 7 is driven by an electric motor 9 in order to circulate the grid belt 4 around the deflection rollers 5 to 8. This causes the upper run 10 of the grid belt 4 to move in a conveying direction 11, which in FIG. 1 runs horizontally from left to right. The objects 2 to be coated with the coating mass 34 rest on the upper run 10 and, resting on the upper run 10, are conveyed one after the other in the conveying direction 11 through a mass application device 12 and a blow-off device 13. The mass application device 12 and the blow-off device 13 are arranged above and inside a trough 14, which receives excess coating mass 34, that already runs off in and behind the mass application device 12 through the upper run 10 of the grid belt 4 and that is blown off from the objects 2 in the blow-off device 13 with the aid of supplied air 15, because it is excess applied coating mass 34. The mass application device 12 may be designed very differently and may already apply the coating mass 34 to the objects 2 before the objects are placed on the upper run 10 of the grid belt 4 of the conveyor device 3 in order to guide them through the blow-off device 13.

FIG. 2 shows a section of the upper run 10 of the grid belt 4. The grid belt 4, designed by the shapes of its individual grid bars 20, is divided in the transverse direction to the conveying direction 11 into alternately successive object receiving areas 16 and low areas 17. The object receiving areas 16 are used to support the objects 2. In FIG. 2, however, only objects 2 that are supported on the middle of the three object receiving areas 16 are shown. The object support areas 16 have alternating object supports 18 and object driving dogs 19 in the conveying direction 11. In the object support area, the individual grid bars 20 of the grid belt 4 define flat, horizontally oriented object supports 18. The object driving dogs 19 are raised by a few millimeters, for example 8 mm, beyond these object supports. The object driving dogs 19 ensure that the objects 2 in the object removal areas 16 follow one another at defined intervals in the conveying direction and follow the upper run 10 in the conveying direction 11 at the same speed.

On both sides of each object receiving area, one of the low areas 17 is arranged, running through in the conveying direction 11 and lowered relative to the respective object receiving area 16. Lower ends 21 of first parts 22 of the blow-off device 13 are lowered above the low areas to below the object support 18. The first parts 22 of the blow-off device 13 have rows 23 of blow-out openings 24, which are lowered above the respective low area 17 to a height level below the top of the object support 18. The blow-out openings 24 define first blow-out positions 25 at which gas jets are blown out horizontally and transversely to the conveying direction 11 in order to blow off excess applied coating mass from the undersides 26 of the objects 2 resting on the upper run 10.

Before the objects 2 with the applied coating mass 34 reach the area of action of the first parts 22 of the blow-off device 13, the objects reach the area of action of second parts 27 of the blow-off device, with which the excess applied coating mass is blown off from the two side surfaces 28 of the objects 2 before being blown off from the undersides 26. For this purpose, at least two second gas jets are blown out horizontally and transversely to the conveying direction 11 at second blow-out positions, which are laterally opposite each other in relation to the conveying device and thus opposite the side surfaces 28 of the objects 2.

Even in front of the area of action of the second parts 27 of the blow-off device, a third part 29 of the blow-off device 13 is located along the conveying path of the objects 2 in the conveying direction 11, with which excess coating mass 13 is blown off from the top sides 30 of the objects 2 with at least one third gas jet before being blown off from the two side surfaces 28. The at least one third gas jet is blown out at a third blow-out position, which is arranged above the upper surfaces 30 of the objects 2. The at least one third gas jet may be directed vertically downwards. The at least one third gas jet may be in the form of a sheet and extend over the entire width of the third part 29, which spans all object receiving areas and adjacent low areas.

After the first parts 22 of the blow-off device 13, the objects 2 enter the area of action of a removal device 31 with a wiper roll 32, which removes excess applied coating mass from an underside of the upper run 10 and thus also indirectly from the objects 2 resting on the upper run 10. The wiper roll 32 is driven about an axis of rotation extending in a transverse direction to the conveying direction 11 in such a way that an upper side of the wiper roll 32 which is in contact with the upper run 10 has a direction of movement 33 opposite to the conveying direction 11.

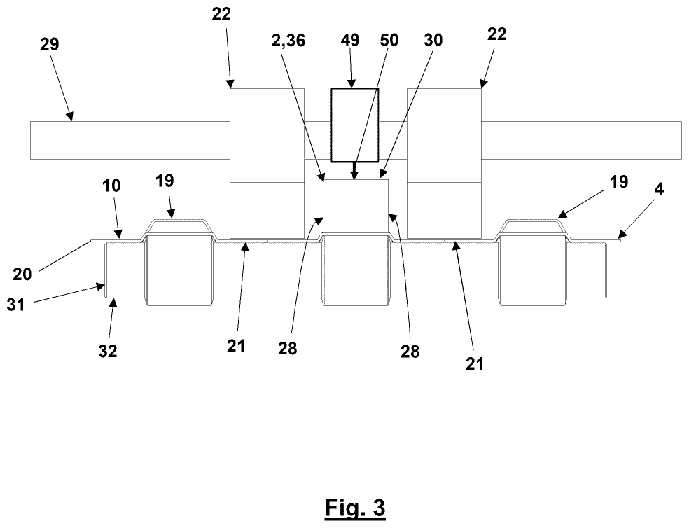

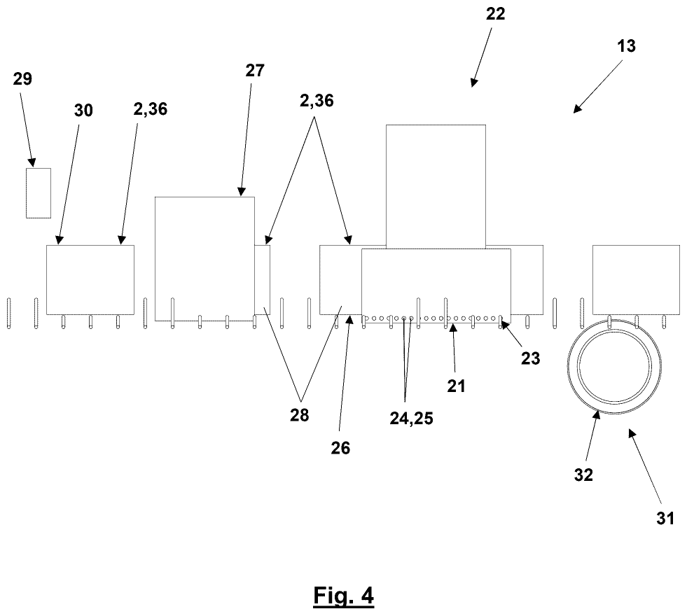

FIG. 3 shows that the wiper roll 32 of the removal device 31 engages the underside of the upper run 10 over the entire width of the grid belt 4, except in the region of the object driving dogs 19, which are raised above the object supports adjacent in the conveying direction 11. FIG. 3 also shows a hold-down device 49, which is arranged along the conveying direction 11, which here runs perpendicular to the drawing plane, at the level of the first parts 22 of the blow-off device 13. The hold-down device 49 acts on the objects 2 with a further gas jet 50 directed downwards onto their upper sides 30 in order to hold the objects 2 down on the upper run 10 during the action of the first parts 22 of the blow-off device 13. Further details of the arrangement of the first parts 22, second parts 27 and the third part 29 of the blow-off device 13 relative to the upper run 10 of the conveyor belt 4 and the objects 2 resting thereon are shown in FIG. 4.

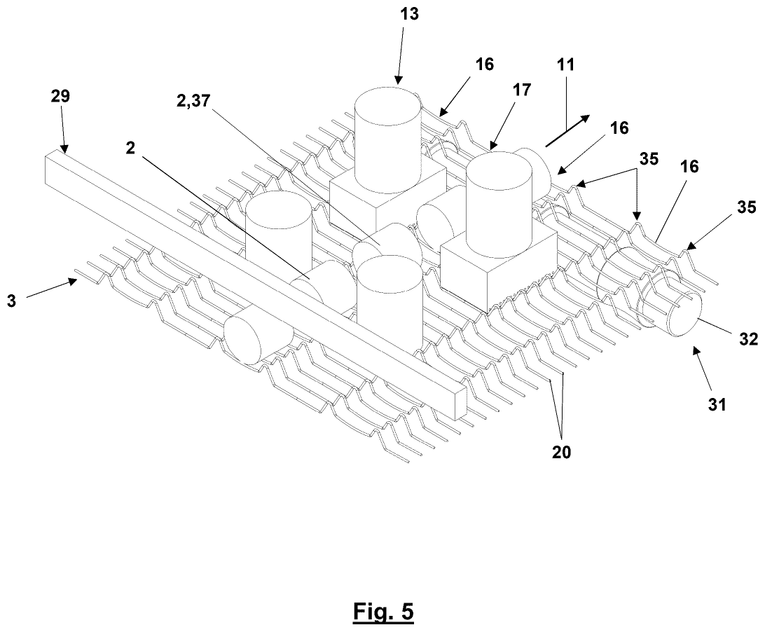

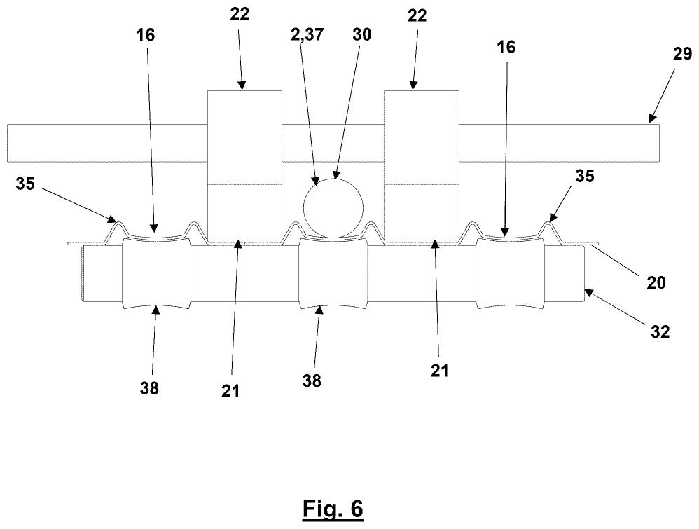

In the conveying device 3, blow-off device 13 and removal device 31 shown in FIG. 5 and FIG. 6, no object supports for the objects 2 are formed in the object receiving areas 16, which are delimited in the conveying direction 11 by object driving dogs. Instead, the object receiving areas 16 are channel-shaped and, viewed in the transverse direction to the conveying direction 11, have raised lateral edges 35, which are formed by spaced-apart convex formations (here triangular formations with tips) of the grid bars 20. Depending on the size of the objects 2, the height of these edges 35 is typically in the range of a few millimeters to a few centimeters. The objects 2 here are not cuboids 36 as in FIGS. 2 to 4, but cylinders 37 whose cylinder axes are oriented in the conveying direction 11. The raised edges 35 prevent the cylinders 37 from rolling down laterally from the object removal areas 16 into one of the low areas 17. FIG. 6 also shows that the object receiving areas 16 are slightly concave between the edges 35 and that the wiper roll 32 has corresponding concave areas 38. In addition, the wiper roll 32 could be molded into the area of the edges 35 in order to engage the grid bars 20 from below over their entire width.

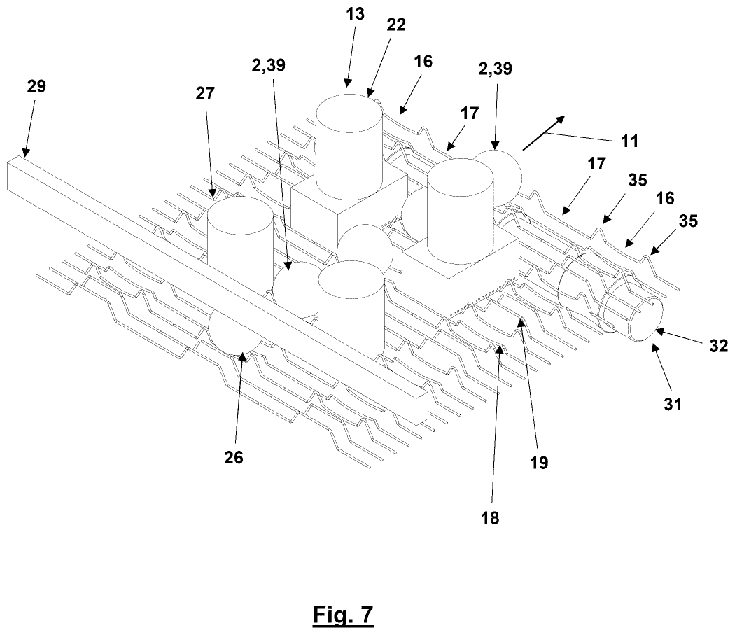

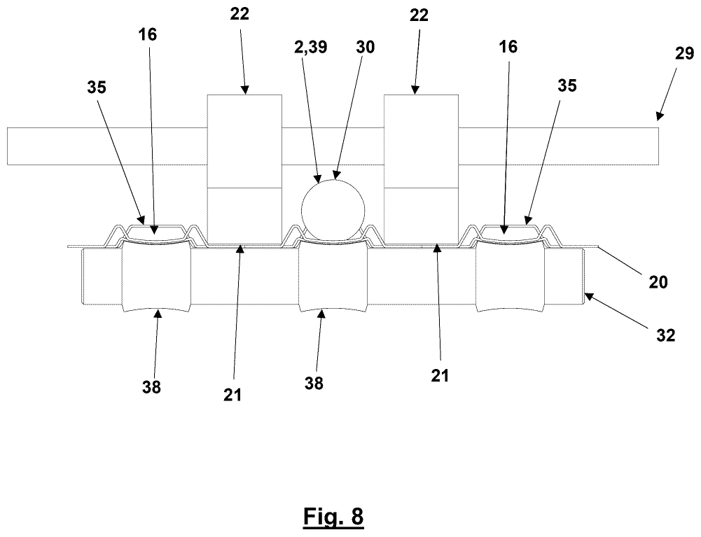

The embodiment of the conveying device 3, the blow-off device 13 and the removal device 31 shown in FIG. 7 and FIG. 8 is configured for blowing off excess applied coating mass 34 from objects 2 in the form of balls 39. Object supports 18 adapted to the shape of the undersides 26 of the balls 39 are formed, which are delimited in the conveying direction 11 by raised object driving dogs 19 and in the transverse direction to the conveying direction 11 by raised edges 35. This ensures that the balls 39 are conveyed safely and at the same time prevents the balls 39 from rolling off the object supports 18, even and especially when the gas jets blown out by the parts 22, 27 and 29 of the blow-off device 13 act on them.

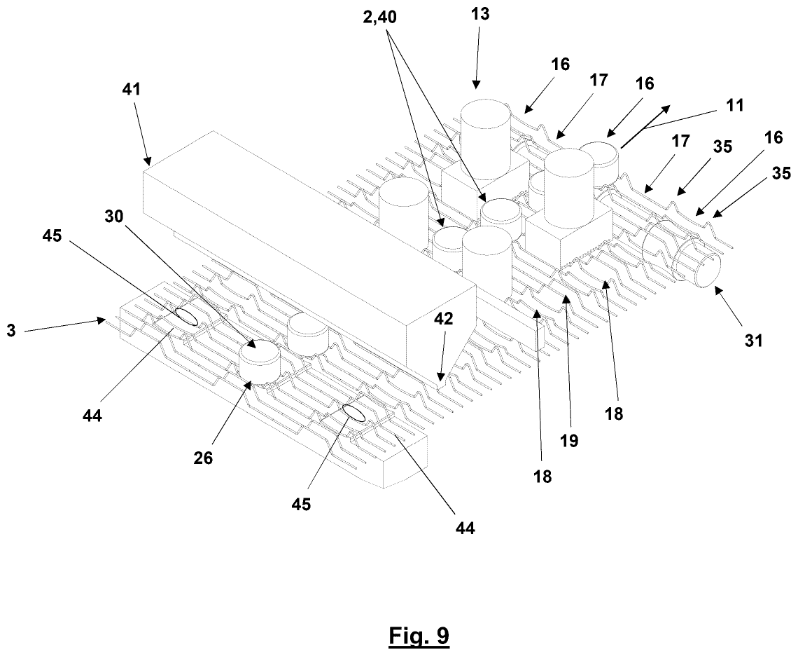

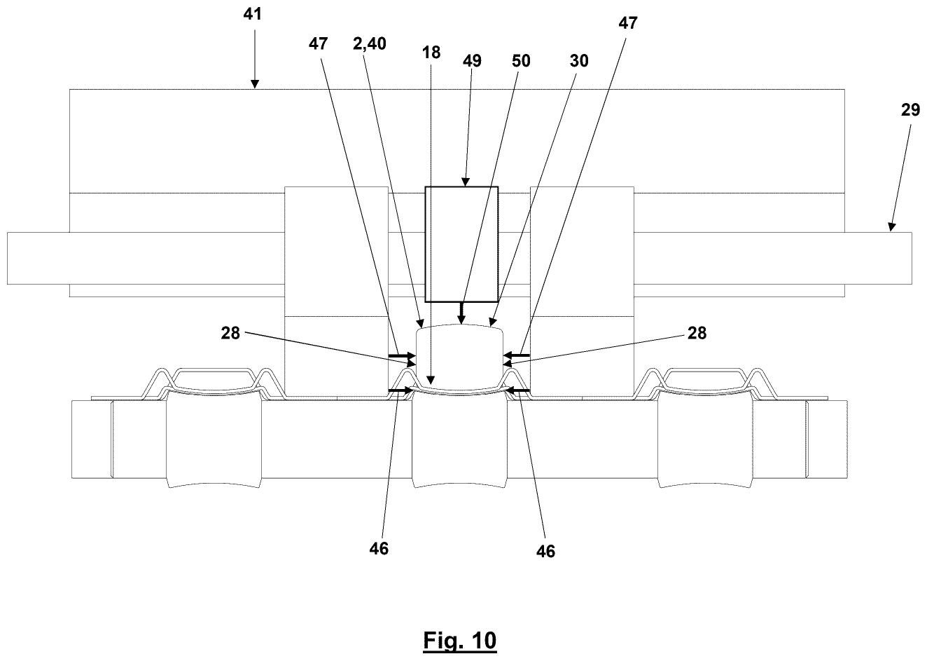

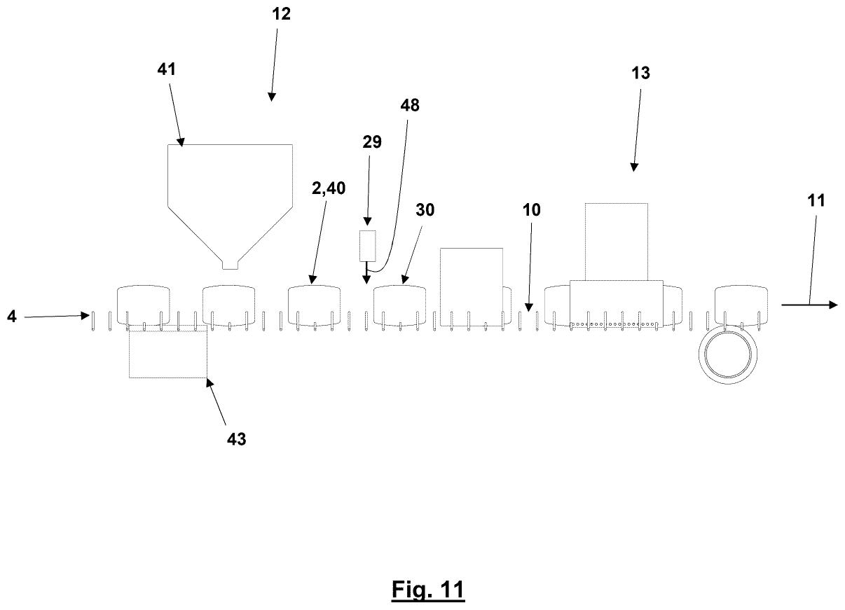

FIG. 9, FIG. 10 and FIG. 11 show a further embodiment of the conveying device 3, the blow-off device 13 and the removal device 31 together with an embodiment of the mass application device 12. The conveying device 3 and the removal device 31 are adapted to objects 2 in the form of pucks 40, which deviate from short upright cylinders by having crowned upper sides 30 and lower sides 26. The object supports 18, which are adapted to the shape of the objects 2 and delimited by object driving dogs 19 and raised edges 35, are similar to the object supports 18 for the balls 39 shown in FIGS. 7 and 8 and may even match. The mass application device 12 additionally shown in FIGS. 9 to 11 has a veil box 41 arranged above the upper run 10, from which a veil 42 (only indicated in FIG. 11) of the coating mass 34 runs downwards onto the objects 2. Below the upper run 10 of the grid belt 4, the mass application device 12 has a so-called bottom levee 43, which has a levee top side 44 corresponding to the underside of the upper run 10 of the grid belt and, in the region of each object receiving area 16, an upwardly directed mass outlet opening 45 in the levee top side 44. Using the mass application device 12, the coating mass 34 is applied to the objects 2 from above and below and thus to all surfaces of the objects 2. The blow-off device 13 following in the conveying direction 11 ensures that this results in a thin but closed coating of the coating mass 34 on all surfaces of the objects 2 and that excess applied coating mass 34 is removed by blowing off.

FIGS. 10 and 11 show examples of first gas jets 46 blown out horizontally from the first parts 22 of the blow-off device 13 below the object supports 18, second gas jets 47 blown out by the second parts 27 of the blow-off device 13 onto the side surface 28 of the objects 2 and a third gas jet 48 blown out vertically from above by the third part 29 of the blow-off device 13 onto the upper sides 30 of the objects 2. In order to be able to better recognize the gas jets 46 and 47, FIG. 10 is shown enlarged compared to FIGS. 9 and 11.

Many variations and modifications may be made to the preferred embodiments of the invention without departing substantially from the spirit and principles of the invention. All such modifications and variations are intended to be included herein within the scope of the present invention, as defined by the following claims.

We claim:

1. A method of coating objects with a flowable coating mass, the method comprising:
applying a flowable coating mass to objects, each object having an upper side, side surfaces and an underside,
arranging the objects on an upper run of a grid belt,
conveying the objects resting on the upper run by moving the upper run in a conveying direction, and
blowing off excess applied coating mass from the objects resting on the upper run and conveyed in the conveying direction, wherein the step of blowing off excess applied coating mass from the objects includes:
blowing out at least one first gas jet at a first blow-out position that is located below the undersides of the objects resting on the upper run and, with respect to the conveying direction, laterally beside the undersides of the objects resting on the upper run, and
blowing off excess applied coating mass from the undersides of the objects resting on the upper run and conveyed in the conveying direction using the at least one first gas jet.

2. The method of claim 1, further comprising:
holding the objects down on the upper run in the region of the at least one first gas jet, viewed in the conveying direction,
wherein the step of holding the objects down includes directing at least one further gas jet downwards onto the upper sides of the objects resting on the upper run.

3. The method of claim 1, further comprising, before the step of blowing off the excess applied coating mass from the undersides of the objects,
blowing out at least two second gas jets at second blow-out positions that, with respect to the conveying direction, are laterally opposite the side surfaces of the objects, and
blowing off excess applied coating mass from the side surfaces of the objects resting on the upper run and conveyed in the conveying direction using the at least two second gas jets.

4. The method of claim 3, further comprising, before the step of blowing off the excess applied coating mass from the side surfaces of the objects,
blowing out at least one third gas jet at a third blow-out position that is located above the upper sides of the objects, and
blowing off excess applied coating mass from the upper sides of the objects resting on the upper run and conveyed in the conveying direction using the at least one third gas jet.

5. The method of claim 1, wherein the step of blowing off excess applied coating mass from the undersides of the objects resting on the upper run and conveyed in the conveying direction includes using at least two first gas jets, wherein the at least two first gas jets include the at least one first gas jet and are blown out at first blow-out positions that include the first blow-out position and that are located below the undersides of the objects and, with respect to the conveying direction, on both sides beside the undersides of the objects.

6. The method of claim 1, wherein the step of blowing off excess applied coating mass from the undersides of the objects resting on the upper run and conveyed in the conveying direction includes using at least one group of first gas jets, wherein the first gas jets of the at least one group of first gas jets include the at least one first gas jet and are blown out at first blow-out positions that include the first blow-out position and that are located below the undersides of the objects and, with respect to the conveying direction, laterally beside the undersides of the objects one behind the other.

7. The method of claim 1, wherein the step of blowing off excess applied coating mass from the undersides of the objects resting on the upper run and conveyed in the conveying direction includes using at least two groups of first gas jets, wherein the first gas jets of the at least two groups of first gas jets include the at least one first gas jet and are blown out at a plurality of first blow-out positions that include the first blow-out position and that are located below the undersides of the objects and, with respect to the conveying direction, on both sides beside the undersides of the objects one behind the other.

8. A coating machine for coating objects with a flowable coating mass, comprising:
a mass application device configured for applying a flowable coating mass to objects,
a conveying device having a circulating grid belt with an upper run and configured for conveying the objects resting on the upper run of the grid belt by moving the upper run in a conveying direction, and
a blow-off device arranged above the upper run of the grid belt and configured for blowing off excess applied coating mass from the objects resting on the upper run and conveyed in the conveying direction,
wherein the upper run, viewed in a transverse direction to the conveying direction, comprises:
at least one object receiving area having an upper side with object support points and, on at least one side of the at least one object receiving area, a low area that runs through in the conveying direction and that is lowered relative to the at least one object receiving area,
wherein a lower end of the blow-off device can be lowered or is lowered above the low area to a height level below the lowest object support points of an upper side of the at least one object receiving area.

9. The coating machine of claim 8, wherein the lower end of the blow-off device comprises at least one blow-out opening which can be lowered or is lowered above the low area at least partially to a height level below the lowest object support points of the at least one object receiving area.

10. The coating machine of claim 9, wherein the at least one blow-out opening is oriented horizontally towards the at least one object receiving area.

11. The coating machine of claim 8, further comprising a hold-down device, wherein the hold-down device, viewed in the conveying direction, is arranged above the upper run in a region of the lower end of the blow-off device and configured to direct at least one further gas jet downwards onto the upper sides of the objects resting on the upper run and conveyed in the conveying direction in order to hold the objects down on the upper run.

12. The coating machine of claim 8, wherein the low area is lowered by at least 3 mm below the lowest object support points of the at least one object receiving area.

13. The coating machine of claim 8, wherein in the at least one object receiving area object supports and object driving dogs are formed which alternately follow to one another in the conveying direction, wherein the object driving dogs are raised beyond the object supports.

14. The coating machine of claim 13, wherein the object driving dogs are raised by at least 2 mm beyond the object supports.

15. The coating machine of claim 8, wherein the at least one object receiving area, viewed in the transverse direction to the conveying direction, has a channel shape at least in the region of object support points.

16. The coating machine of claim 15, wherein lateral edges of the at least one object receiving area are raised by at least 2 mm beyond the lowest object support points of the at least one object receiving area.

17. The coating machine of claim 8, further comprising a removal device arranged below the upper run and configured for removing excess applied coating mass from at least one of an underside of the upper run and the undersides of the objects resting on the upper run and conveyed in the conveying direction, the removal device engaging on the upper run in both the at least one object receiving area and the low area.

18. The coating machine of claim 17, wherein the removal device comprises a wiper roll which is driven for rotation about an axis of rotation extending in a transverse direction to the conveying direction.

19. The coating machine of claim 8, wherein the application device comprises a veil box arranged above the upper run and a bottom levee arranged below the upper run.

20. The coating machine of claim 19, wherein the bottom levee has a levee top side corresponding to the underside of the upper run at least in the at least one object receiving area, and an upwardly directed coating mass outlet opening in the levee top side.
